(19) United States
(12) Patent Application Publication
(10) Pub. No.: US 2025/0310035 A1
(43) Pub. Date: Oct. 2, 2025

(54) TECHNOLOGIES FOR RADIO LINK CONTROL POLL TRIGGERING

(71) Applicant: Apple Inc., Cupertino, CA (US)

(72) Inventors: Ping-Heng Kuo, London (GB); Alexander Sirotkin, Tel Aviv (IL); Peng Cheng, Beijing (CN); Haijing Hu, Los Gatos, CA (US); Ralf Rossbach, Munich, Bavaria-Bayern (DE); Fangli Xu, Beijing (CN); Yuqin Chen, Beijing (CN); Naveen Kumar R. Palle Venkata, San Diego, CA (US); Zhibin Wu, Los Altos, CA (US)

(73) Assignee: Apple Inc., Cupertino, CA (US)

(21) Appl. No.: 19/067,653

(22) Filed: Feb. 28, 2025

Related U.S. Application Data
(60) Provisional application No. 63/572,891, filed on Apr. 1, 2024.

(51) Int. Cl. H04L 1/1607; H04W 28/06; H04W 76/20

(52) U.S. Cl. CPC H04L 1/1685; H04W 28/06; H04W 76/20

(57) ABSTRACT

The present application relates to devices and components including apparatus, systems, and methods for RLC poll triggering.

### CROSS-REFERENCES TO OTHER APPLICATIONS

This application claims priority to U.S. Provisional Application No. 63/572,891, for “TECHNOLOGIES FOR RADIO LINK CONTROL POLL TRIGGERING” filed on Apr. 1, 2024, which are herein incorporated by reference in their entirety for all purposes.

### TECHNICAL FIELD

This application relates generally to communication networks and, in particular, to the poll triggering in radio link control (RLC) acknowledgment mode (AM).

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates aspects of a user equipment in further detail in accordance with some embodiments.

FIG. 3 illustrates a timing diagram in accordance with some embodiments.

FIG. 4 illustrates a radio link control signal flow diagram in accordance with some embodiments.

FIG. 5 illustrates data flow in accordance with some embodiments.

FIG. 6 illustrates aspects of a transmitting entity in accordance with some embodiments.

FIG. 7 illustrates a network environment in accordance with some embodiments.

FIG. 8 illustrates another operation flow/algorithmic structure in accordance with some embodiments.

FIG. 9 illustrates another operation flow/algorithmic structure in accordance with some embodiments.

FIG. 10 illustrates another operation flow/algorithmic structure in accordance with some embodiments.

FIG. 11 illustrates another operation flow/algorithmic structure in accordance with some embodiments.

FIG. 12 illustrates another operation flow/algorithmic structure in accordance with some embodiments.

FIG. 13 illustrates another operation flow/algorithmic structure in accordance with some embodiments.

FIG. 14 illustrates a user equipment in accordance with some embodiments.

FIG. 15 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

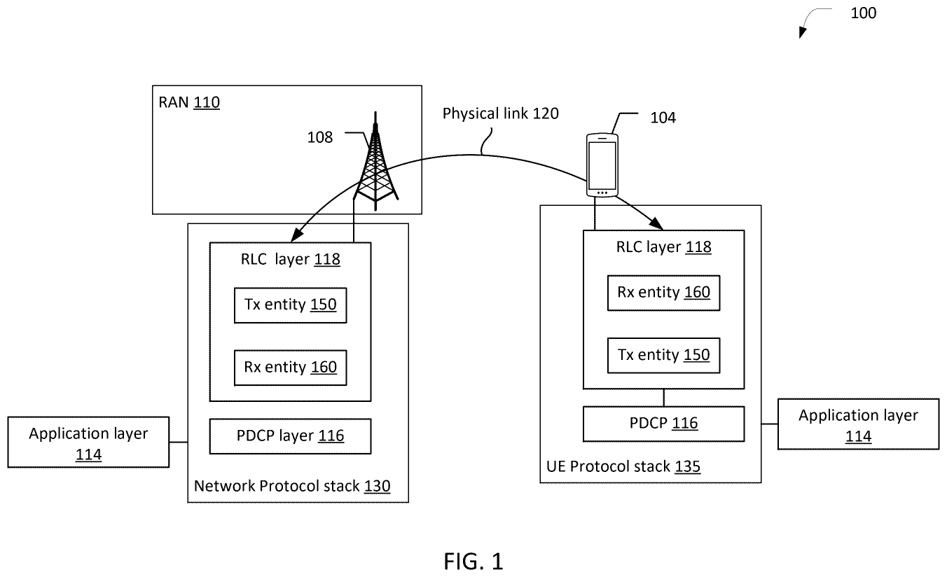

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The 3GPP TSs may define a protocol stack, e.g., network protocol stack 130 or UE protocol stack 135. The protocol stack may be a set of communication protocols. In some examples, the protocol stack may be designed in a layered architecture for modularity, with each layer providing specific functions. The design may allow changes in one layer without affecting others, facilitating upgrades and improvements. The layers may include a physical layer (Layer 1, L1, or PHY) responsible for establishing and maintaining a physical link 120. Bits of control and data may transmit over the air interface and the physical link 120. The protocol stack, e.g., network protocol stack 130 or UE protocol stack 135, may include a data link layer (Layer 2, L2), which may be divided into a medium access control (MAC), a radio link control (RLC) 118, and a packet data convergence protocol (PDCP) 116 sub-layers. Layer 2 may be responsible for managing the UE 104 connectivity and movement between cells and networks. In some instances, application layer 114 is not included in the protocol stack.

The RLC 118 sub-layer may be responsible for reliable data transmission. The RLC 118 may include a transmitting entity 150 and a receiving entity 160. The transmitting entity 150 at the transmitting end may segment the data from higher layers, e.g., PDCP layer 116 or application layer 114, and add sequence numbers and headers. These packets may then be transmitted over the air interface, e.g., via the physical link 120. At the receiver end, the receiving entity 160 of the RLC layer 118 may reassemble the packets back into the original data, e.g., using the sequence numbers and header information to ensure correct order and to detect any missing packets. If a packet is detected as missing or erroneous, the RLC layer 118 at the receiver can request retransmission from the transmitter.

In the downlink transmission, the base station 108 is the transmitting end, and the UE 104 is the receiving end. The transmitting entity 150 of the RLC 118 of the base station 108 sends the packets via the physical link 120 to the UE 104. The receiving entity 160 of the RLC layer 118 of the UE 104 receives and reassembles the packets. In some embodiments, the packet transmitted by an RLC layer 118 may be referred to as an RLC protocol data unit (PDU).

The receiving entity 160 of RLC layer 118 of the base station 108 may be called a peer entity to the transmitting entity 150 of RLC layer 118 of the UE 104. Similarly, the receiving entity 160 of RLC layer 118 of the UE 104 may be called a peer entity to the transmitting entity 150 of RLC layer 118 of the base station 108.

In some instances, a packet received by a layer from higher layers is called the service data unit (SDU) of that layer. The packet transmitted by the layer to lower layers is called the PDU of that layer. For example, packets received to PDCP layer 116 are called PDCP SDUs, and packets sent from PDCP layer 116 to RLC layer 118 are called PDCP PDUs.

The RLC layer 118 may be configured as an acknowledgment mode (AM) RLC. In AM RLC, each transmitted PDU is assigned a sequence number. The receiver may send acknowledgments (ACKs) for correctly received PDUs and negative acknowledgments (NACKs) for missing or erroneous PDUs. Upon receiving a NACK, or in the absence of an ACK associated with a PDU, the transmitter may retransmit the corresponding PDU.

In some embodiments, the application layer 114 may generate packets and group them in PDU sets. The PDCP layer 116 may receive the packets and generate PDCP PDUs. Each PDCP PDU may be associated with one or more application layer packets or a PDU set. The RLC layer 118 may receive the PDCP PDUs and generate RLC PDUs. Each RLC PDU may be associated with one or more PDCP PDUs and similarly may be associated with one or more application layer packets or a PDU set.

In some embodiments, when a PDCP SDU is received from the upper layer, the transmitting PDCP entity may start a discard timer. The discard timer may track the buffered time of each SDU at the PDCP layer 116. In some instances, when the discard timer expires for a PDCP SDU or the successful delivery of the PDCP SDU is confirmed, e.g., via an ACK, the transmitting PDCP entity may discard the PDCP SDU along with the corresponding PDCP PDU.

In some instances, discarding PDCP SDUs that are not successfully delivered may cause the retransmission of the entire PDU set associated with the discarded PDCP SDUs. Retransmission of the entire PDU set associated with discarded PDCP SDUs may be unnecessary and inefficient, waste network resources, increase latency, and/or negatively impact the user experience. It is desirable to prevent PDCP SDU discarding due to discard timer expiry.

In some embodiments, when RLC PDUs are delivered to lower layers for transmissions, a copy of the RLC PDU may be buffered for retransmission. The RLC PDU may remain in the retransmission buffer until the receiver side of the RLC receives an ACK or a NACK associated with the RLC PDU. The RLC PDU is removed from the retransmission buffer if an ACK is received. However, if a NACK is received, the transmitting side of the RLC may retransmit the RLC PDU. In some instances, the RLC PDUs in the retransmission buffer may stall or prevent the initial transmission of new RLC PDUs. In some instances, when a packet becomes delay-critical, many other packets belonging to the same PDU set may also become delay-critical. Thus, it is desirable that the transmission and retransmission buffers are not stalled.

To expedite moving PDUs out of the retransmission buffer, a transmitting entity, the transmitting entity 150 of the base station 108, may poll its peer receiving entity, e.g., the receiving entity 160 of the UE 104. The polling may request transmission of a status report carrying the ACKs or NACKs associated with the RLC PDUs transmitted by the transmitting entity 150.

In some embodiments, once delay-critical RLC SDUs are detected, a poll may be triggered based on one or more conditions. A poll may trigger the receiver to provide the status report, facilitating the transmission or retransmission of buffered PDU in the transmission or retransmission buffers.

In some embodiments, the transmitting side of the RLC AM entity may further determine triggering a poll based on attributes or conditions of the PDU sets corresponding to the delay-critical RLC SDUs.

In some embodiments, if the poll is triggered by delay-critical packets, the transmitting entity 150 of RLC AM may send a notification to the peer receiving entity 160 to indicate to the receiver that delay-critical packets trigger the poll.

In some embodiments, the peer receiving entity 160 may stop or ignore a prohibit timer, prohibiting the transmission of status report, based on the notification from the transmitting entity 150.

In some embodiments, the transmitting entity 150 may regularly provide information about delay-critical packets, RLC PDUs or RLC SDUs, to the peer receiving entity 160.

In some embodiments, the receiver entity 150 may provide status PDU proactively. The receiving entity 160 may determine a condition and autonomously or proactively generate a status report.

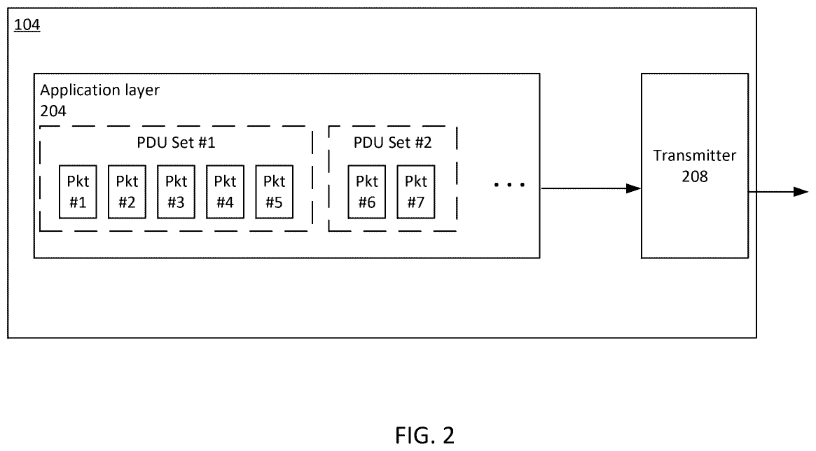

FIG. 2 illustrates aspects of the UE 104 in further detail in accordance with some embodiments. The UE 104 may include an application layer 204 that generates application traffic to be transmitted to another device through the network environment 100. In some embodiments, the application layer 204 may have an XR application that generates XR traffic. However, embodiments are not limited to XR use cases.

For XR and other services, the application layer 204 may generate PDU sets, with individual PDU sets comprising one or more packets. A packet also referred to as a PDU, may be an Internet protocol (IP) packet or a non-IP packet. As shown, PDU set #1 may include packets #1-#5, while PDU set #2 includes packets #6 and #7. Each PDU set may be mapped to a different QoS flow. Different PDU sets may be mapped to different traffic flows when they correspond to different traffic flows or modalities.

The packets of a PDU set may carry a payload of one unit of information generated by the application layer. The unit of information may be a frame or video slice for XR Services, such as those defined in 3GPP Technical Report (TR) 26.926 v18.1.0 (2024-01), for example. In some implementations, all PDUs in the PDU Set may be needed by an application layer at a destination node to allow the application layer to recover parts or all of the information unit. In other implementations, the application layer on the destination node may still be able to recover parts or all of the information unit, even if some PDUs of a PDU set are missing.

In some embodiments, the data produced by an application layer of the UE 104 may include multi-modal data. Multi-modal data may include input data from different devices/sensors or output data to different destinations (e.g., one or more UEs) desired for the same task or application. Multi-modal data may include more than one single-modal data (e.g., one type of data), and there may be a strong dependency among each single-modal data associated with multi-modal data.

In some embodiments, the data produced by an application layer may be in a data burst. A data burst may include, for example, data produced by the application layer in a short period of time. The data burst may include PDUs from one or more PDU Sets.

The PDU sets may be provided to a transmitter 208 of the UE 104. The transmitter 208 may be configured to execute a communication protocol stack, for example, UE protocol stack 135 of FIG. 1, to facilitate communication via the network environment 100. The transmitter 208 may implement L2 and L1 functionality. At the L2 level, transmitter 208 may include a service data adaptation protocol (SDAP) layer, a PDCP layer, an RLC layer, and a MAC layer. At the L1 level, the transmitter 208 may include a physical (PHY) layer. Briefly, the SDAP layer may manage QoS flow handling between the QoS flows and the data radio bearers (DRBs). The PDCP layer may manage robust header (de)compression and security between DRBs and RLC channels. The RLC layer may manage (re-)segmentation and error correction through automatic repeat requests (ARQ) between logical channels and RLC channels. The MAC layer may manage scheduling/priority handling, (de)multiplexing, and hybrid automatic repeat request (HARQ) processes between logical channels and transport channels. The PHY layer may manage the processing of the physical data and control channels.

In some embodiments, various information may be provided by the core network node to the RAN 110 to assist in handling QoS flows and PDUs. This information may be consistent with that described in 3GPP TR 23.700-60 v18.0.0 (2022-12-21). This information may include semi-static information for both uplink and downlink, PDU set QoS parameters, and dynamic information for downlink.

The semi-static information for both uplink and downlink may be provided via the control plane (NGAP). This information may include periodicity for uplink and downlink traffic of the QoS Flow via time-sensitive communications assistance information (TSCAI)/time-sensitive communications assistance container (TSCAC); and traffic jitter information (e.g., jitter range) associated with each periodicity of the QoS flow.

The PDU set QoS parameters may include a PDU Set Error Rate (PSER) to define an upper bound for the rate of PDU Sets that have been processed by the sender of a link layer protocol but that are not successfully delivered by the corresponding receiver to the upper layer. See, for example, 3GPP TR 23.700-60. In some instances, a PDU set may be considered as successfully delivered when all PDUs of a PDU Set are delivered successfully. In other instances, other definitions of successful delivery may be made. In some instances, if one PDU of a PDU set is discarded, all remaining PDUs of the PDU set may be discarded.

The PDU set QoS parameters may further include a PDU Set Delay Budget (PSDB) that defines a time between the reception of a first PDU and the successful delivery of a last-arrived PDU of a PDU Set. See, for example, 3GPP TR 23.700-60. The PSDB may be an optional parameter in various embodiments.

The PDU set QoS parameters may further include a PDU Set importance (PSI) to indicate the relative importance of a PDU set compared to other PDU sets within the same QoS flow.

A PDU set may be associated with the following information: a PDU set sequence number (SN); a PDU set size (in bytes); a PDU SN within a PDU Set; an end PDU of the PDU Set indication; a PDU set importance (PSI); and an end of data burst indication in the header of a last PDU of the data burst. The PSI may be used to identify the importance of a PDU Set within a QoS flow. The RAN 110 may use the PSI for PSI-based discarding in the presence of congestion, as described herein.

The application, application server, application function, or application layer 114 may assign a PSI level for each packet or PDU set or may define rules and policies for assigning a PSI level to a type of packet or PDU set. For example, the application may assign a PSI level to packets associated with audio data and a different PSI to packets or PDU sets associated with real-time video data. The application may assign different PSI to payloads associated with different video frame types within a video stream. PSI level selection may be influenced by factors such as type of application (e.g., video, audio, text), details of codec (e.g., H.264 or high-efficiency video coding, HEVC), level of error propagation when a PDU set is discarded, or inter-dependency among PDU sets (e.g., whether a PDU set is necessary for the processing of some other PDU sets). The PSI selection may be similar to that described in 3GPP TS 26.522 v 0.4.0 (2024-03-01).

PSI may have N levels, e.g., levels 0 to N-1. The higher PSI level values may be associated with less importance. Some of the PSI levels may indicate no interdependency with other PDU sets. For example, there may be 16 levels of PSIs, e.g., level 0 to level 15. PSI levels 14 and 15 may indicate no inter-dependency to other PDU sets; e.g., a PDU set having PSI level 14 may not have inter-dependency to other PDU sets. PDU sets with other PSI levels, e.g., levels 0 to 13, may be needed to process other PDU sets. These values may differ in other embodiments.

In some instances, the base station 108 may instruct the UE 104 to apply different discarding timers for PDU sets with different PSIs. For example, a PDU set with a large PSI level may have a shorter discard timer than a PDU set with a smaller PSI level.

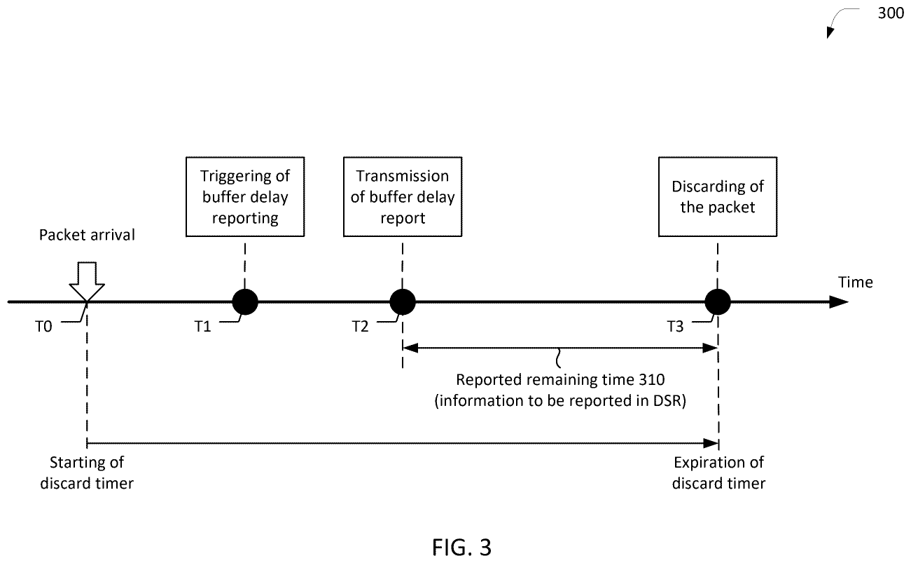

FIG. 3 illustrates a timing diagram 300 for generating and transmitting a delay status report in accordance with some embodiments. The delay status reporting (DSR) may assist in delay-aware scheduling. A DSR may be triggered when the remaining time till the data is discarded is below a threshold.

At T₀, a buffer of a transmitting entity (e.g., UE PDCP transmitting entity in uplink transmission or base station PDCP transmitting entity in downlink transmission) and associated with a logical channel (LCH) or a logical channel group (LCG) can receive a data packet for transmission. At T₀, the transmitting entity can start a discard timer, in which it will discard the data if, by expiration of the timer, the transmitting entity has not successfully transmitted the data packet. At T₁, a first time interval (e.g., T₃-T₁) is reached, where the time remaining prior to the expiration of the discard timer has reached a threshold, such that a delay status report (DSR) is triggered. At T₂, a DSR report is generated and transmitted. The DSR can include data volume information. For example, the DSR may include the buffer size or a reported remaining time 310, when the DSR is transmitted. The reference point for measuring the reported remaining time 310 may be the transmission of DSR. UE may report the DSR in a MAC control element (CE).

As mentioned above, DSR may include buffer size. The UE may determine the buffer size through data volume calculation. 3GPP TS 38.323 v. 18.0.0 (2024-01) describes data volume calculation for delay status reporting.

3GPP TS 38.323 introduces delay-critical PDCP SDUs to calculate buffer size for the DSR. Similarly, 3GPP TS 38.322 v. 18.0.0 (2024-01) introduces delay-critical RLC SDUs to calculate buffer size for DSR.

The delay-critical PDCP SDU may be defined as a PDCP SDU for which the remaining time till discarding is less than a first threshold when PDU set discarding is not configured. When the PDU set discarding is configured, a PDCP SDU is delay-critical if it belongs to a PDU set in which at least one PDCP SDU has the remaining time till discarding less than a second threshold. Note that the remaining time till discarding is the actual remaining time of the discard timer, whereas the reported remaining time 310 is the remaining time on the discard timer at the time of generating or transmitting the DSR. Similarly, a delay-critical RLC SDU is defined as an RLC SDU corresponding to a PDCP PDU indicated as delay-critical by PDCP.

In some instances, for the purpose of MAC delay status reporting, the transmitting PDCP entity may be considered as delay-critical PDCP data volume: 1) the delay-critical PDCP SDUs for which no PDCP Data PDU have been constructed; 2) the PDCP Data PDU that contain the delay-critical PDCP SDUs and have not been submitted to lower layers; 3) the PDCP Control PDUs; 4) for AM data radio bearers (DRBs), the PDCP SDUs to be retransmitted; and 5) for AM DRBs, the PDCP Data PDUs to be retransmitted.

In some instances, for the purpose of MAC buffer status reporting, the UE may consider the following as RLC data volume: 1) RLC SDUs and RLC SDU segments that have not yet been included in an RLC data PDU; 2) RLC data PDUs that are pending for initial transmission; and 3) RLC data PDUs that are pending for retransmission (RLC AM). Additionally, the UE may also consider the following as delay-critical RLC data volume: 1) delay-critical RLC SDUs and delay-critical RLC SDU segments that have not yet been included in an RLC Data PDU; 2) RLC Data PDUs pending for initial transmission and containing a delay-critical RLC SDU or a delay-critical RLC SDU segment; and 3) RLC Data PDUs that are pending for retransmission (RLC AM). In addition, if a status PDU has been triggered and a prohibition timer, t-StatusProhibit, is not running or has expired, the UE may estimate the size of the status PDU that will be transmitted in the next transmission opportunity and consider this as part of RLC data volume for MAC buffer status reporting and as part of delay-critical RLC data volume for MAC delay status reporting.

In some embodiments, an identifier associated with an RLC SDU may indicate whether it is delay-critical, e.g., a one-bit indicator. RLC PDUs may be considered delay-critical if they are associated with delay-critical RLC SDUs or delay-critical RLC SDU segments. RLC Data PDUs of both initial transmission or retransmission may be considered as delay-critical.

In some embodiments, an RLC SDU or SDU segment may be associated with a parameter associated with the discard timer or the PDCP SDU associated with the RLC SDU or SDU segment. The parameter may include a value of the remaining time till discarding, e.g., the remaining time till the discard timer expires.

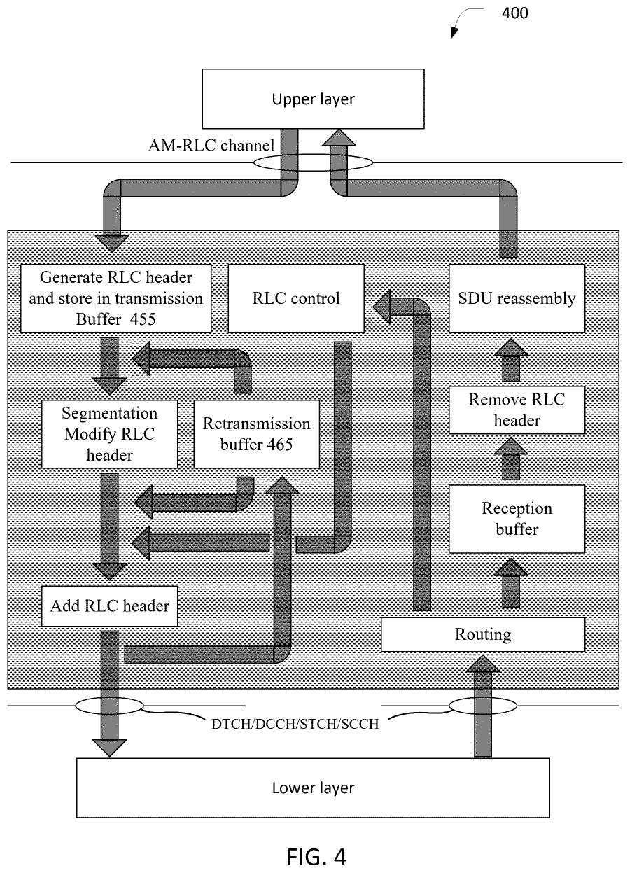

FIG. 4 illustrates an RLC signal flow diagram 400 in accordance with some embodiments. Signal flow diagram 400 is an example of functionalities performed by the RLC layer, e.g., RLC layer 118 in FIG. 1.

An example of an AM RLC entity is described in 3GPP TS 38.322. An AM RLC entity may be configured to submit or receive RL CPDUs through the following logical channels: downlink (DL) or uplink (UL) dedicated control channel (DCCH), DL or UL dedicated traffic channel (DTCH), sidelink control channel (SCCH), and sidelink traffic channel (STCH).

An AM RLC entity may deliver or receive the following RLC Data PDUs: AMD PDU. An AMD PDU may contain either one complete RLC SDU or one RLC SDU segment. An AM RLC entity may deliver or receive the following RLC control PDU: status PDU. The status PDU may be used to provide the status of the PDUs that are correctly received and lost during transmission. It is sent from the RLC receiving entity, e.g., receiving entity 160 in FIG. 1, to the transmitting entity, e.g., transmitting entity 150 in FIG. 1. The status PDU may contain an ACK or NACK sequence number.

The transmitting side of an AM RLC may generate AMD PDU(s) for each RLC SDU. Upon receiving a transmission opportunity from the lower layer, the transmitting side of the AM RLC entity may break down the RLC SDUs into segments. This is done so that the resulting AMD PDUs, with appropriately updated RLC headers, can fit within the total size of the RLC PDU(s) specified by the lower layer.

The transmitting side of an AM RLC entity may also support the retransmission of RLC SDUs or RLC SDU segments. If the RLC SDU or RLC SDU segment to be retransmitted (including the RLC header) exceeds the total size of the RLC DU(s) specified by the lower layer at a given transmission opportunity, the AM RLC entity may break down the RLC SDU into segments or resegment the RLC SDU segments into smaller segments.

When the AM RLC entity on the receiving end receives AMD PDUs, it may identify if there are any duplicated AMD PDUs and discard them. The AM RLC may also recognize if any AMD PDUs have been lost at lower layers and ask its peer AM RLC entity for retransmission. Finally, the AM RLC may reassemble the RLC SDUs from the AMD PDUs it received and pass the RLC SDUs to the upper layer as soon as they are ready.

AM RLC may include two buffers. The first buffer may be the transmission buffer 455. The transmission buffer 455 may store RLC AMD PDUs. After an RLC PDU has been transmitted, a similar copy is stored in the retransmission buffer 465, the second buffer. If the RLC receives a NACK or does not get any positive response, the RLC PDU from the retransmission buffer may be transmitted again.

In some instances, the RLC SDUs are included in RLC PDUs and submitted to a lower layer for transmission. The RLC protocol may track RLC SDUs that have been submitted for transmission and decide to retransmit a buffered RLC PDU based on the associated RLC SDUs.

The transmitting side of an RLC transmitting entity, e.g., transmitting entity 150, may solicit a status PDU from its peer entity at the receiving side. For example, the transmitting entity 150 of the base station 108 may solicit a status PDU from the receiving entity 160 of the UE 104, or the transmitting entity 150 of the UE 104 may solicit a status PDU from the receiving entity 160 of the base station 108.

The transmitting side may solicit a status PDU from its peer entity through the header of an AMD PDU. The transmitting side of a transmitting entity 150 may set a polling flag in the header of an AMD PDU sent to the peer receiving entity 160 and received by the receiving side of the peer receiving entity 160. The transmitting side may set the polling flag when the total number of PDUs transmitted since the last poll or status report (parameter: PDU_WITHOUT_POLL) is equal or greater than a threshold, e.g., the configured pollPDU threshold; when the total number of bytes of the RLC PDUs transmitted since the last poll or status report is received (BYTE_WITHOUT_POLL) is greater than or equal to another threshold, e.g., the configured pollByte threshold; when the transmission and retransmission buffer becomes empty (excluding transmitted RLC SDUs or RLC SDU segments awaiting acknowledgments) after the transmission of the current AMD PDU; when no new RLC SDU can be transmitted after the transmission of the AMD PDU, e.g., due to window stalling; or when the poll retransmit timer expires. Once the polling flag is set, a status PDU from the receiving side is solicited. This mechanism may allow the transmitting side to request its peer to send the current status.

Once the polling flag is set, e.g., by setting the poll bit to ‘1’ in an AMD PDU, the transmitting side may start or restart a poll retransmit timer. For example, the transmitting side may start a configured t-PollRetransmit timer. The timer is stopped when a status PDU is received. If the timer expires, the transmitting side may initiate data retransmission or retransmit the poll.

In some instances, the receiving side may determine which PDUs to report based on the sequence numbers (SNs) and segment offsets (SOs) of the received AMD PDUs. The report may be a control PDU, e.g., status PDU. The receiving side may generate the status report and include the SNs of the received PDUs and the SNs of the lost PDUs or segments. TS 38.322 describes RLC AM polling and associated operations and timers, e.g., the t-PollRetransmit timer.

In some instances, the transmitting side of an AM RLC entity may maintain a transmitting window. The transmitting window may provide orderly transmission of AMD PDUs. It may be used to control the number of PDUs that can be transmitted before receiving an acknowledgment. Two parameters may determine the transmitting window: 1) parameter “AM_Window_Size,” which is the size of the window in terms of the number of PDUs, and 2) parameter TX_Next_Ack, which is the sequence number of the next RLC SDU for which a positive acknowledgment is expected to be received in-sequence. If an AMD PDU has a sequence number, PDU_SN, that is greater than or equal to the TX_Next_Ack and smaller than Tx_Next_Ack+AM_Window_Size, the AMD PDU may be transmitted.

The Tx_Next_Ack may serve as the lower edge of the transmitting window. The Tx_Next_Ack+AM_Window_Size may serve as the upper edge of the transmitting window. A new RLC SDU with SN outside the transmitting window cannot be transmitted. Therefore, it is desirable for the transmitting window to move forward as quickly as possible. When the transmitting window moves forward, the subsequent new packets are less likely to be delayed by window stalling. The transmitting window will move forward by receiving ACK for PDUS with SN equal to Tx_Next_Ack. The transmitter may proactively request ACK or NACK, e.g., via a polling mechanism from the receiver side.

In some instances, some RLC SDUs (or their segments) may be considered for retransmission. For example, when the peer RLC entity does not positively acknowledge some RLC SDUs. Retransmission of an RLC SDU may be performed several times before it is positively acknowledged. In some instances, the number of retransmissions may be capped by a threshold, e.g., configured threshold maxRetxThreshold.

When an RLC SDU or an RLC SDU segment is considered for retransmission, a counter, e.g., configured RETX_COUNTER, may be assigned to the RLC SDU or RLC SDU segment that is being retransmitted. If the RLC SDU or RLC SDU segment is being considered for retransmission for the first time, the counter is set to zero, e.g., RETX_COUNT=0. The counter may be incremented if the RLC SDU or its segment is not pending for retransmission and the RETX_COUNT associated with the RLC SDU has not been incremented due to another NACK in the same status PDU.

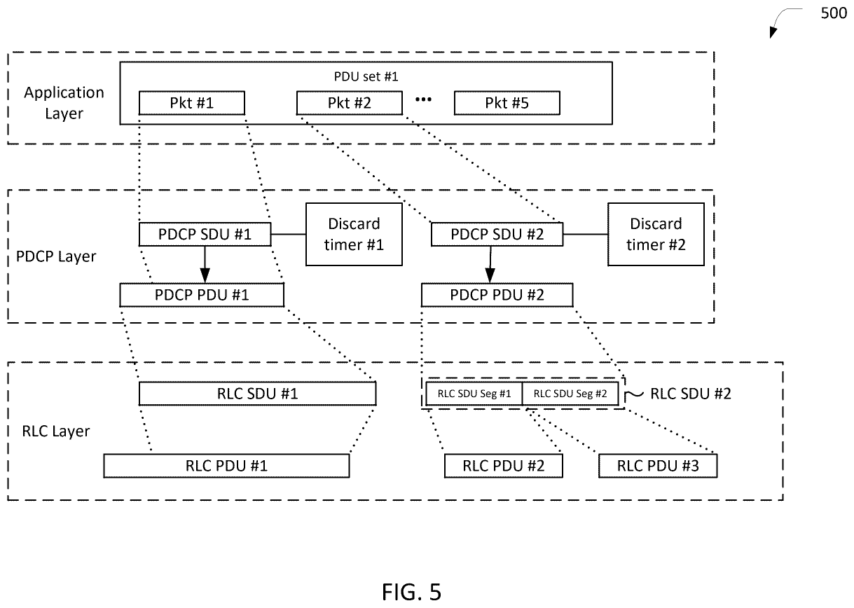

FIG. 5 illustrates data flow 500 in accordance with some embodiments. Data flow 500 is a logical example diagram of protocol layers and the data flow through various layers. Application layer, e.g., application layer 204 in FIG. 2, may generate PDU set #1, including packets #1-#5. Packet #1 of the PDU set #1 may be mapped to PDCP SDU #1. Upon receiving the PDCP SDU #1, the PDCP layer may configure and start a discard timer #1 and associate it with the PDCP SDU #1. Similarly, Packet #1 of the PDU set #1 may be mapped to PDCP SDU #2. Upon receiving the PDCP SDU #2, the PDCP layer may configure and start a discard timer #2 and assign it to the PDCP SDU #2.

PDCP layer may include PDCP SDU #1 in PDCP PDU #1. PDCP PDU #1 may also include a header and other information. Similarly, PDCP SDU #2 may be included in PDCP PDU #2 with other information.

At the RLC layer, PDCP PDU #1 and a PDCP PDU #2 may be included in RLC SDU #1 and RLC SDU #2, respectively. The RLC SDU #1 may be included in the RLC PDU #1 along with RLC header and other information. A segment of the RLC SDU #2, e.g., RLC SDU Seg #1 may be included in RLC PDU #2 along with RLC header and other information, and the second segment of the RLC SDU #2, e.g., RLC SDU Seg #2 along with RLC header and other information may be included in RLC PDU #3.

There might be two ways that an RLC SDU may become delay-critical. In one example, the RLC SDU is delay-critical and is associated with a delay-critical PDCP PDU. A PDCP PDU may be delay-critical if it is associated with a delay-critical PDCP SDU. As described above, a PDCP SDU may become delay-critical when the remaining time of the associated discard timer is less than a threshold. For example, if PDCP SDU #2 becomes delay-critical, then PDCP PDU #2, RLC SDU Segment #1, RLC SDU segment #2, RLC PDU #2, and RLC PDU #3 will become delay-critical as well.

In a second example, the RLC SDU or PDU may become delay-critical if it is associated with a PDU set where a packet of that PDU set is associated with a delay-critical PDCP SDU. For example, if PDCP SDU #1 becomes delay-critical, in the first example, only RLC SDU #1 and RLC PDU #1 would become delay-critical, and RLC SDU Segment #1, RLC SDU Segment #2, RLC PDU 2 and RLC PDU #3 would not become delay-critical. However, in the second example, when PDCP SDU #1 becomes delay-critical, it is associated with packet #1 of PDU set #1. Therefore, PDCP SDU #2 associated with packet #2 of the PDU set #1 would also become delay-critical. Consequently, PDCP PDU #2, RLC SDU segment #1, RLC SDU Segment #2, RLC PDU #2, RLC PDU #3, PDCP PDU #1, RLC SDU #1, and RLC PDU #1 would become delay-critical.

Due to the nature of PDU sets, in some instances, when a packet becomes delay-critical, many other packets belonging to the same PDU set may also become delay-critical, e.g., when the PDU set discard is configured.

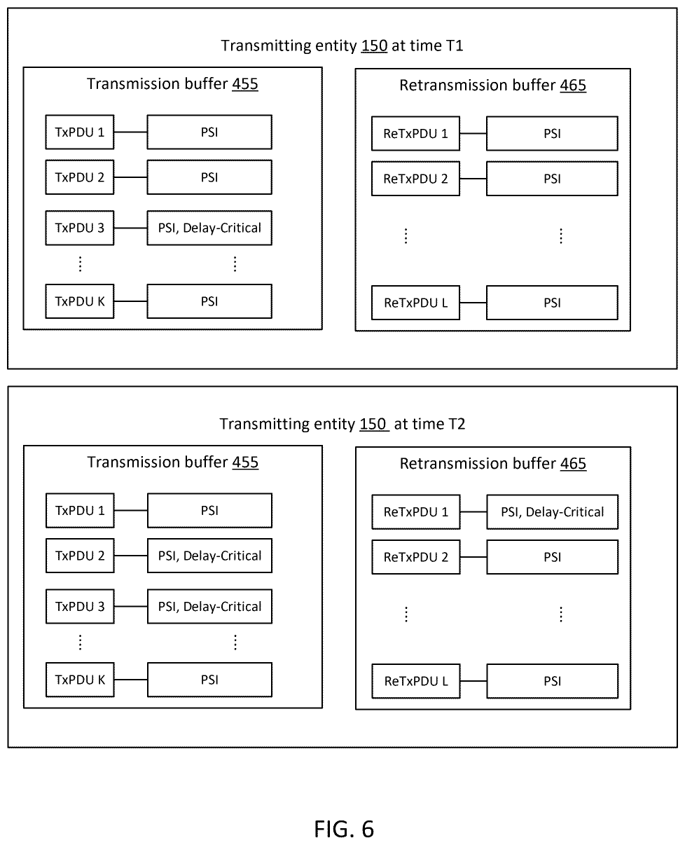

FIG. 6 illustrates aspects of an RLC transmitting entity 600 in accordance with some embodiments. RLC Transmitting entity 150 is illustrated at two different times, T1 and T2. Transmitting entity 150 includes a transmission buffer 455 and a retransmission buffer 465.

At time T1, transmission buffer 455 may store transmitting PDUs 1-K. Only transmitting PDU 3 may be delay-critical. Similarly, retransmission buffer 465 may store retransmitting PDUs 1-L. None of the retransmitting PDUs may be delay-critical. In some instances, information may be associated with each PDU in the transmission buffer 455 or retransmission buffer 465. Information may include a PSI field or a delay-critical indicator.

At time T2, transmitting PDU 2 and retransmitting PDU 1 may become delay-critical. For example, the discarding timer associated with the transmitting PDU 2 and retransmitting PDU 1 may become smaller than a threshold. The transmitting entity 150 at T2 may update information associated with transmitting PDU 2 and retransmitting PDU 1 accordingly to reflect that these PDUs are delay-critical.

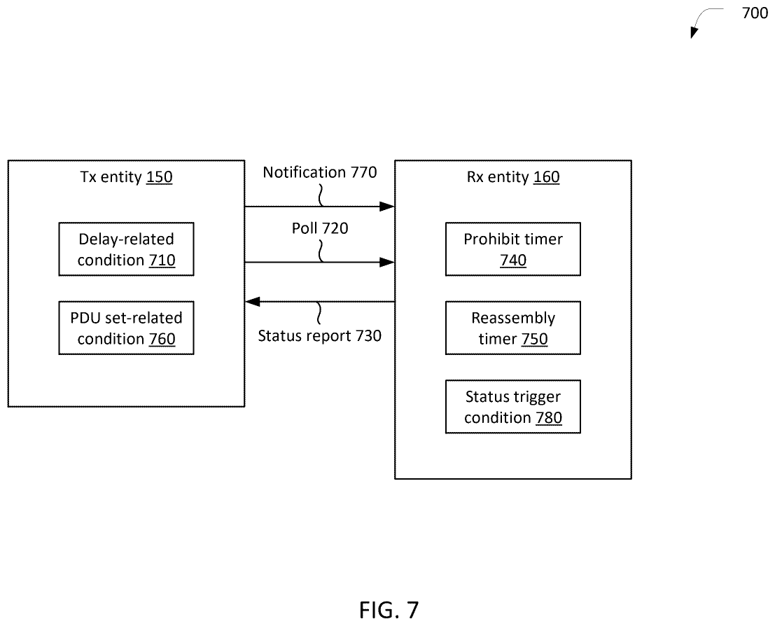

FIG. 7 illustrates a network environment 700 in accordance with some embodiments. The network environment 700 may include the transmitting entity 150 and the receiving entity 160. The transmitting entity 150 is generating RLC data PDUs for transmission to the receiving entity 160. Receiving entity 160 may generate status report 730 to indicate successful reception, e.g., ACK, or failure in receiving, e.g., NACK, of the PDU sent by the transmitting entity 150. As described above, if ACK or NACK indications associated with the RLC PDUs or SDUs are not received, the transmission window at the transmitting entity 150 may stall, causing the new SDUs to backlog and not be transmitted.

The transmitting entity 150 may request the receiving entity 160 to send the status report 730. The transmitting entity 150 may send a poll 720 to the receiving entity 160 to request the status report 730. For example, the transmitting entity 150 may send the poll 720 by setting a polling flag in an RLC AMD PDU. A set of conditions based on the number of RLC PDUs sent total bytes sent, or the status of transmission or retransmission buffers 455 or 465 described above that may trigger the poll 720. The transmitting entity 150 may trigger polling the status report 730 from the receiving entity 160 when there is a delay-critical RLC SDU.

The transmitting entity 150 may trigger polling based on the detection of a delay-related condition 710. The transmitting entity 150 may trigger polling based on the delay-related condition 710 when a delay-critical RLC SDU is present in the RLC transmitting entity 150.

The delay-related condition 710 may include several conditions. In some embodiments, the transmitting entity 150 may trigger polling the status report 730 if at least one RLC SDU received in the transmitter buffer 455 from the higher layer is considered delay-critical. In some embodiments, the transmitting entity 150 may trigger polling the status report 730 if the number of RLC PDUs corresponding to delay-critical RLC SDUs sent since the last status report is received satisfies a threshold. For example, poll 720 is sent if the number of RLC PDUs corresponding to delay-critical RLC SDUs sent since the last status report is greater than or equal to a threshold. The threshold may be configured, e.g., via RRC configuration signaling.

In some embodiments, the transmitting entity 150 may trigger polling the status report 730 if the number of bytes of RLC PDUs corresponding to delay-critical RLC SDUs sent since the last status report is received satisfies a threshold. For example, poll 720 is sent if the number of bytes of RLC PDUs corresponding to delay-critical RLC SDUs sent since the last status report received is greater than or equal to a threshold. The threshold may be configured, e.g., via RRC configuration signaling.

In some embodiments, the transmitting entity 150 may trigger polling the status report 730 if the number of RLC PDUs sent since the last transmission of an RLC PDU corresponding to delay-critical RLC SDUs satisfies a threshold. For example, a poll 720 is triggered when the sequence number gap between the latest RLC PDU corresponding to a delay-critical SDU, e.g., associated with the largest sequence number of delay-critical PDUs, and the last RLC PDU corresponding to a delay-critical SDU, e.g., associated with the smallest sequence number of the delay-critical PDUs, is larger than the threshold.

In some embodiments, the transmitting entity 150 may trigger polling the status report 730 if the number of bytes of RLC PDUs sent since the last transmission of an RLC PDU corresponding to delay-critical RLC SDUs satisfies a threshold. For example, a poll 720 is triggered when the number of bytes of RLC PDUs sent since the last transmission of an RLC PDU corresponding to delay-critical RLC SDUs is greater than or equal to a threshold. The threshold may be configured, e.g., via RRC configuration signaling.

In some embodiments, the transmitting entity 150 may trigger a poll 720 when two or more of the above conditions are detected. For example, in one embodiment, the transmitting entity 150 may trigger polling the status report 730 if at least one RLC SDU arrived in the transmitter buffer 455 is considered delay-critical, and the number of RLC PDUs corresponding to delay-critical RLC SDUs sent since the last status report is received satisfies a threshold, e.g., is greater than or equal to the threshold. In another embodiment, the transmitting entity 150 may trigger polling the status report 730 if at least one RLC SDU arrived in the transmitter buffer 455 is considered delay-critical, and the number of RLC PDUs sent since the last transmission of an RLC PDU corresponding to delay-critical RLC SDUs satisfies a threshold, e.g., is greater than or equal the threshold.

The thresholds associated with delay-related condition 710 may be pre-configured, e.g., by RRC signaling, defined by specifications, e.g., 3GPP TSs, or may be an implementation parameter of the base station 108 or the UE 104. In some embodiments, the threshold may be based on pollPDU and pollByte as defined in 3GPP TSs. In some embodiments, the threshold may be separately configured frompollPDU and pollByte, and the values may always be smaller or larger than pollPDU or pollByte.

In some embodiments, the transmitting entity 150 may determine whether to trigger transmission of poll 720 based on PDU set-related condition 760. The PDU set-related conditions 760 may include conditions associated with the PSI, PDU set size, e.g., in bytes, the number of PDUs in the PDU set, or whether the end PDU of the PDU set is delivered to the RLC transmitting entity 150. In some embodiments, the transmitting entity 150 may first determine whether a delay-related condition 710 is met and then may trigger the poll 720 if a PDU set-related condition 760 is met.

For example, poll 720 may be triggered when the delay-critical RLC SDU (in the transmission buffer 455 or already transmitted) considered in delay-related condition 710 is also associated with a packet belonging to an important PDU set, e.g., having a PSI that is less than a threshold or has a prespecified PSI value. In some embodiments, the PSI is taken into account only if the PSI-based discarding mechanism is configured or activated on the corresponding data radio bearer (DRB). When the PSI-based discarding mechanism is disabled, the transmitting entity 150 of the RLC AM may not consider PSI when deciding if poll 720 should be triggered by the presence of delay-critical SDUs.

In another example, poll 720 may be triggered when the delay-critical RLC SDU (in the buffer or already transmitted) considered in delay-related condition 710 is associated with a PDU set packet with a total size (in bytes) exceeding a threshold.

In some instances, whether a packet is considered delay-critical or not is based on the 3GPP TSs definitions, i.e., if the remaining time of a packet (or the packet in the same PDU set) until PDCP discard timer expiry is smaller than a threshold, e.g., remainingTime Threshold. In some instances, delay-critical packets may be identified by other parameters or definitions, e.g., based on how long a packet has been queued in a buffer, e.g., buffers 455 or 465, or whether the remaining time is smaller than thresholds different from remainingTimeThreshold.

In some embodiments, upon notification of a transmission opportunity by the lower layer, for each AMD PDU submitted for transmission, the transmitting side of an AM RLC entity may: if both the transmission buffer 455 and the retransmission buffer 465 becomes empty (excluding transmitted RLC SDUs or RLC SDU segments awaiting acknowledgments) after the transmission of the AMD PDU; or if no new RLC SDU can be transmitted after the transmission of the AMD PDU (e.g., due to window stalling); or if at least one delay-critical RLC SDU is present in the buffer (e.g., buffer 455 or 465); then include a poll 720 in the AMD PDU (e.g., as described in the 3GPP TSs).

Upon notification of a transmission opportunity by the lower layer, for each AMD PDU submitted for transmission such that the AMD PDU contains either a not previously transmitted RLC SDU or an RLC SDU segment containing a not previously transmitted byte segment, the transmitting side of an AM RLC entity may: increment PDU_WITHOUT_POLL by one; increment BYTE_WITHOUT_POLL by every new byte of Data field element that it maps to the Data field of the AMD PDU; if PDU_WITHOUT_POLL>=pollPDU; or if BYTE_WITHOUT_POLL>=pollByte, then include a poll in the AMD PDU as described below.

Upon notification of a transmission opportunity by lower layer, for each AMD PDU submitted for transmission such that the AMD PDU contains either a not previously transmitted delay-critical RLC SDU or a delay-critical RLC SDU segment containing not previously transmitted byte segment, the transmitting side of an AM RLC entity may: increment DELAY_PDU_WITHOUT_POLL by one; increment DELAY_BYTE_WITHOUT_POLL by every new byte of Data field element corresponding to a delay-critical RLC SDU or a delay-critical RLC SDU segment that it maps to the Data field of the AMD PDU; if DELAY_PDU_WITHOUT_POLL>=pollDelayPDU; or if DELAY_BYTE_WITHOUT_POLL>=pollDelayByte, then include a poll in the AMD PDU as described below.

Poll 720 may be triggered to solicit the transmission of the status report 730 from the receiving entity 160. In some instances, the receiving entity 160 may not provide status report 730 immediately, even if it is triggered by the poll 720. For instance, a prohibit timer 740 may be running at the receiving entity 160, preventing the receiving entity 160 from sending the status report 730 while the prohibit timer 740 is running. The receiving entity 160 may send the status report 730 when the prohibit timer has expired.

For example, when status report 730 has been triggered, the receiving side of an AM RLC entity may: if prohibit timer 740, e.g., t-StatusProhibit, is not running: at the first transmission opportunity indicated by the lower layer, construct a status report 730, e.g., a STATUS PDU, and submit it to lower layer; else: at the first transmission opportunity indicated by lower layer after the prohibit timer 740, e.g., t-StatusProhibit, expires, construct a single status report 730, e.g., STATUS PDU, even if status reporting was triggered several times while prohibit timer 740, e.g., t-StatusProhibit, was running and submit it to the lower layer.

In some embodiments, when the poll 720 is triggered by delay-critical packets, delay-related condition 710, or PDU set-related condition 760, the transmitting side of RLC AM, e.g., the transmitting entity 150, may send an indication or a notification 770 to inform the receiving entity 160 that the poll 720 is triggered based on a delay-critical packet, a delay-related condition 710, or PDU set-related condition 760. In some embodiments, notification 770 may be one or more fields in the AMD PDU, including the polling flag indicating that the polling has been triggered. The notification 770 may determine the condition for triggering the poll 720. In some embodiments, notification 770 may be one or more fields in the AMD PDU that indicate sequence numbers corresponding to delay-critical packets whose status are being polled or requested.

At the receiving entity 160, based on the indication of poll triggering by the presence of delay-critical packets, delay-related condition 710, or PDU set-related condition 760, the receiving entity 160 may send status report 730 even if the prohibit timer 740, e.g., t-StatusProhibit, is running. In some embodiments, the receiving entity 160 may ignore or stop the prohibit timer 740, allowing it to send status report 730 immediately.

In some embodiments, the transmitting entity 150 may regularly provide information about delay-critical packets, e.g., SDUs or PDUs, to the receiving entity 160, even without poll triggering. Based on the information related to delay-critical PDUs or SDUs, the receiving entity 160 may trigger generating the status report 730 autonomously. In some embodiments, the receiving entity 160 may trigger status report 730 based on a condition such as when at least N>=1 delay-critical packets are present in the receiver buffer, or the sequence number gap between two delay-critical packets in the receiver buffer exceeds a threshold.

In some embodiments, the receiving entity 160 may proactively trigger reporting status report 730. For example, an AM RLC receiving entity 160 may send status report 730, e.g., STATUS PDUs, to its peer AM RLC transmitting entity 150 in order to provide positive or negative acknowledgments of RLC SDUs (or portions of them). Triggers to initiate status report 730, e.g., STATUS reporting, may include: receiving poll 720 from its peer AM RLC entity, e.g., transmitting entity 150, or detecting a reception failure of an AMD PDU.

Triggers to initiate status report 730 may include receiving poll 720 from peer transmitting entity 150: when an AMD PDU with SN=x and the P field set to “1” is received from the lower layer, the receiving of an AM RLC receiving entity 160 may: if the AMD PDU is to be discarded, e.g., as specified in the 3GPP TSs; or if x<RX_Highest_Status or x>=RX_Next+AM_Window_Size: then trigger a status report 730, e.g., STATUS report; else: delay triggering the status report 730, e.g., STATUS report, until x<RX_Highest_Status or x>=RX_Next+AM_Window_Size. Where RX_Next is the sequence number following the sequence number of the last fully received RLC SDU. RX_Next is updated when an SUD with a sequence number equal to RX_Next is fully received. Where RX_Highest_Status is the highest possible value to be indicated in the ACK_SN field of a status report 730, e.g., STATUS PDU, SDUs with lower sequence numbers that have not been fully received will be indicated with NACK_SN in the status report 730, e.g., STATUS PDU, where ACK_SN is the sequence number of the next RLC data PDU expected to be received. It may be used to acknowledge the receipt of all RLC data PDUs with a sequence number less than ACK_SN, where NACK_SN is the sequence number of an RLC data PDU that has not been successfully received and is awaiting retransmission. It may indicate that all RLC data PDUs with sequence numbers higher than NACK_SN have not been successfully received.

Triggers to initiate status report 730 may include detecting a reception failure of an AMD PDU, e.g., when reassembly timer 750, e.g., t-Reassembly, expires.

In some instances, when a PDU segment is received from the lower layer and placed in the reception buffer, and at least one byte segment of the corresponding SDU is missing, the receiving entity 160 may start a reassembly timer 750, e.g., t-Reassembly, if it is not already running. The purpose of the reassembly timer 750 may be to detect the loss of PDUs at the receiving entity 160. If the reassembly timer 750 expires, it may trigger a status report 730.

Proactive transmission of status report 730 may ensure that the RLC status report 730 is transmitted after hybrid automatic repeat request (HARQ) reordering.

In some instances, the expiry of reassembly timer 750, e.g., t-Reassembly, may trigger RX_Highest_Status to be updated and status report 730, e.g., STATUS report, to be triggered. In some instances, the status report 730 may be triggered after RX_Highest_Status is updated.

In some instances, the receiving entity 160 may send the status report 730, e.g., STATUS PDU, when a poll 720 is received from the transmitting entity 150, the reassembly timer 750, e.g., t-Reassembly, is expired, and a prohibit timer 740, e.g., t-StatusProhibit, is not running. These conditions may not allow the transmission of status report 730 as soon as it is polled, which may prevent the transmitting window from moving forward.

In some instances, the receiving entity 160 may provide status report 730 proactively. In some embodiments, the receiving entity 160 may trigger reporting the status report 730 based on the determination of status trigger condition 780 is met. In some embodiment, the receiving entity 160 may proactively trigger the status report 730 whenever an RLC SDU is completely received. In some embodiment, the receiving entity 160 may proactively trigger the status report 730. It may update the state variable of RX_Next, which holds the value of the sequence number following the last in-sequence completely received RLC SDU. In some embodiment, the receiving entity 160 may proactively trigger the status report 730 whenever the number of RLC SDUs that were previously unacknowledged in the last stats report but now have become acknowledged exceeds a threshold. The threshold may be configured, e.g., via RRC configuration signaling. In some embodiment, the receiving entity 160 may proactively trigger the status report 730 periodically. The periodic reporting of status report 730 may be configured, e.g., via RRC signaling. In some embodiments, the UE 104 may send the status report 730 even if the prohibited timer 740, e.g., t-StatusProhibit, is still running. Alternatively, the receiving entity 160 may stop the prohibit timer 740.

In some embodiments, the receiving entity 160 may trigger or send an alternative type of report to indicate ACKs or NACKs or simply include an indication to notify the transmitting entity 150 that the receiving window has moved forward based on the proactive triggering events listed above. The proactive status report 730 may be transmitted as an RLC control PDU, a medium access control (MAC) control element (CE), an uplink control information (UCI), or a downlink control information (DCI).

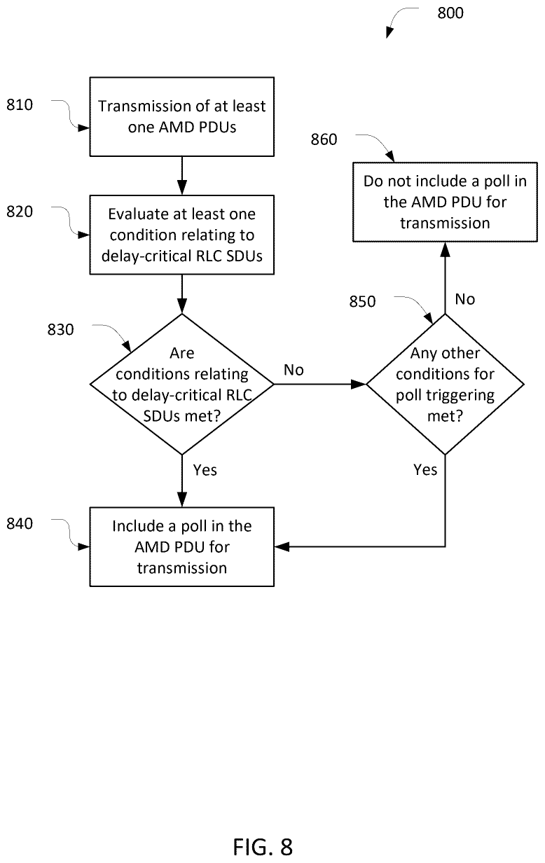

FIG. 8 illustrates another operation flow/algorithmic structure 800 in accordance with some embodiments. The algorithmic structure 800 may be implemented by an RLC transmitting entity such as, for example, the transmitting entity 150 of a UE, such as, for example, the UE 104 or UE 1400, or components thereof, for example, baseband processor circuitry 1404A; or the transmitting entity 150 of a base station, such as, for example, the base station 108 or base station 1500, or components thereof, for example, baseband processor circuitry 1504A.

The operation flow/algorithmic structure 800 may include, at 810, transmitting at least one PDU, e.g., an RLC AMD PDU.

The operation flow/algorithmic structure 800 may include, at 820, evaluating at least one delay-related condition 710 relating to delay-critical RLC SDUs. The delay-related condition 710 may include the conditions discussed above.

The operation flow/algorithmic structure 800 may include, at 830, determining whether a delay-related condition relating to delay-critical RLC SDUs is met. If the delay-related condition relating to delay-critical RLC SDU is met, the operation flow may proceed to 840, and otherwise, it may proceed to 850.

The operation flow/algorithmic structure 800 may include, at 840, including a poll by setting the polling flag in the PDU for transmission. In some instances, each AMD PDU may include a polling flag. If the polling flag is set to “1” it may cause the receiving entity 160 to generate and report a status report 730.

The operation flow/algorithmic structure 800 may include, at 850, determining whether other conditions, e.g., PDU set-related condition 760, are met. Based on the determination that additional conditions, e.g., PDU set-related condition 760, are met, the process may proceed to 840. Otherwise, the process may proceed to 860.

The operation flow/algorithmic structure 800 may include, at 860, not including a poll in the PDU for transmission.

In some embodiments, the positive determination of step 830 may cause proceeding to 850. That is, the additional conditions, e.g., PDU set-related condition 760, are checked once the delay-related condition 710 is met.

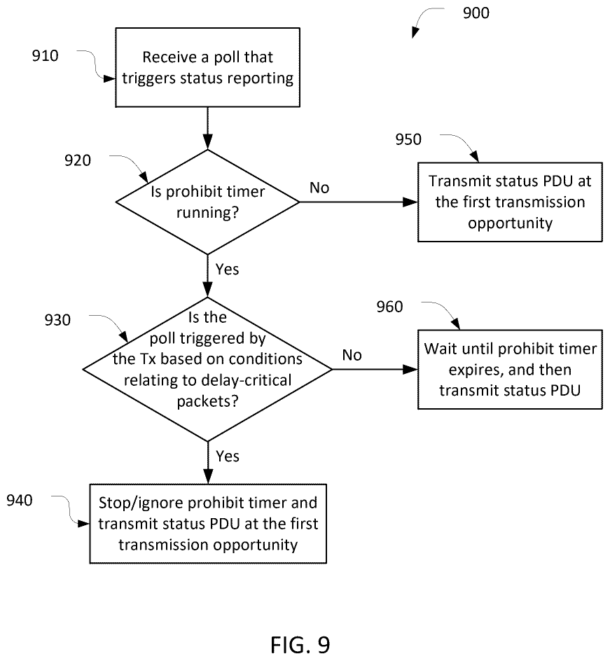

FIG. 9 illustrates another operation flow/algorithmic structure 900 in accordance with some embodiments. The algorithmic structure 900 may be implemented by an RLC transmitting entity such as, for example, the transmitting entity 150 of a UE, such as, for example, the UE 104 or UE 1400, or components thereof, for example, baseband processor circuitry 1404A; or the transmitting entity 150 of a base station, such as, for example, the base station 108 or base station 1500, or components thereof, for example, baseband processor circuitry 1504A.

The operation flow/algorithmic structure 900 may include, at 910, receiving a poll 720 that triggers the transmission of status report 730. The receiving entity 160 may receive poll 720 in an RLC PDU.

The operation flow/algorithmic structure 900 may include, at 920, determining whether prohibit timer 740 is running. If the prohibit timer is running, the process may proceed to 930. Otherwise, the process may proceed to 950.

The operation flow/algorithmic structure 900 may include, at 930, determining whether the poll 720 is triggered by the transmitting entity 150 based on delay-related condition 710, PDU set-related condition 760, or the presence of delay-critical RLC SDUs, related to delay-critical SDUs or delay-critical PDUs. If the poll 720 is triggered based on these conditions, the process may proceed to 940. Otherwise, the process may proceed to 960.

The operation flow/algorithmic structure 900 may include, at 940, stopping or ignoring the prohibit timer 740. Stopping or ignoring the prohibit timer 740 may allow immediate transmission of status report 730 at the first transmission opportunity. Transmission opportunity may be referred to as a time interval at which the RLC entity is allowed to transmit its data.

The operation flow/algorithmic structure 900 may include, at 950, waiting until the prohibit timer 740 expires. The expiration of prohibit timer 740 may allow the transmission of status report 730 at the next transmission opportunity.

The operation flow/algorithmic structure 900 may include, at 960, transmitting the status report 730 at the first transmission opportunity.

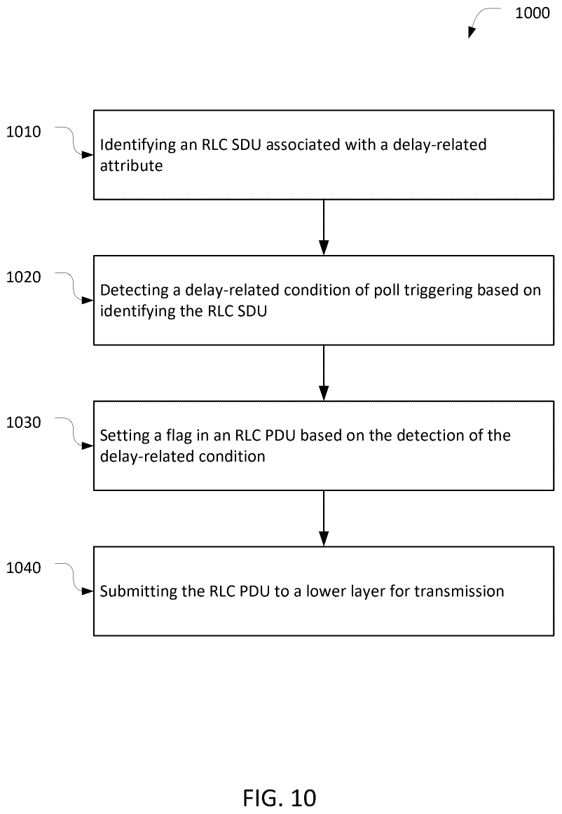

FIG. 10 illustrates another operation flow/algorithmic structure 1000 in accordance with some embodiments. The algorithmic structure 1000 may be implemented by an RLC transmitting entity such as, for example, the transmitting entity 150 of a UE, such as, for example, the UE 104 or UE 1400, or components thereof, for example, baseband processor circuitry 1404A; or the transmitting entity 150 of a base station, such as, for example, the base station 108 or base station 1500, or components thereof, for example, baseband processor circuitry 1504A.

The operation flow/algorithmic structure 1000 may include, at 1010, identifying an RLC SDU associated with a delay-related attribute. The delay-related attribute may be associated with being delay-critical. For example, the transmitting entity 150 may identify the presence of a delay-critical SDU.

The operation flow/algorithmic structure 1000 may include, at 1020, detecting a delay-related condition of poll triggering based on identifying the RLC SDU. Once the presence of a delay-critical RLC SDU is identified, the transmitting entity 150 may detect a delay-related condition associated with triggering a poll. In some instances, the transmitting entity 150 may ignore or not detect delay-related conditions without identifying the presence of a delay-critical RLC SDU.

In some embodiments, detecting the delay-related condition of poll triggering may include: determining that at least one RLC SDU in a transmitter buffer is a delay-critical RLC SDU; determining that a number of RLC PDUs corresponding to delay-critical RLC SDUs sent after a last status report is received is less than a first threshold; determining that a number of bytes of RLC PDUs corresponding to delay-critical RLC PDUs sent after a last status report is received is less than a second threshold; determining that a number of RLC PDUs sent since a last transmission of an RLC PDU corresponding to delay-critical RLC SDUs is less than a third threshold; or determining that a number of bytes of RLC PDUs sent after a last transmission of an RLC PDU corresponding to delay-critical RLC SDUs is less than a fourth threshold.

In some embodiments, detecting the delay-related condition of poll triggering may include: wherein said detecting the delay-related condition of poll triggering may include: determining that a number of RLC PDUs corresponding to delay-critical RLC SDUs sent after a last status report is received is less than the first threshold configured by radio resource control (RRC), determining that a number of bytes of RLC PDUs corresponding to delay-critical RLC PDUs sent after a last status report is received is less than a second threshold configured by RRC; determining that a number of RLC PDUs sent since a last transmission of an RLC PDU corresponding to delay-critical RLC SDUs is less than a third threshold configured by RRC; or determining that a number of bytes of RLC PDUs sent after a last transmission of an RLC PDU corresponding to delay-critical RLC SDUs is less than a fourth threshold configured by RRC.

The operation flow/algorithmic structure 1000 may include, at 1030, setting a polling flag in an RLC PDU based on the detection of the delay-related condition. The transmitting entity 150 may send the poll based on the detection of the delay-related condition by setting the polling flag in an RLC PDU.

The operation flow/algorithmic structure 1000 may include, at 1040, submitting the RLC PDU to the lower layer for transmission.

In some embodiments, the transmitting entity 150 may send a notification to the receiving entity 160. The notification may include a field that indicates one or more sequence numbers associated with delay-critical SDUs.

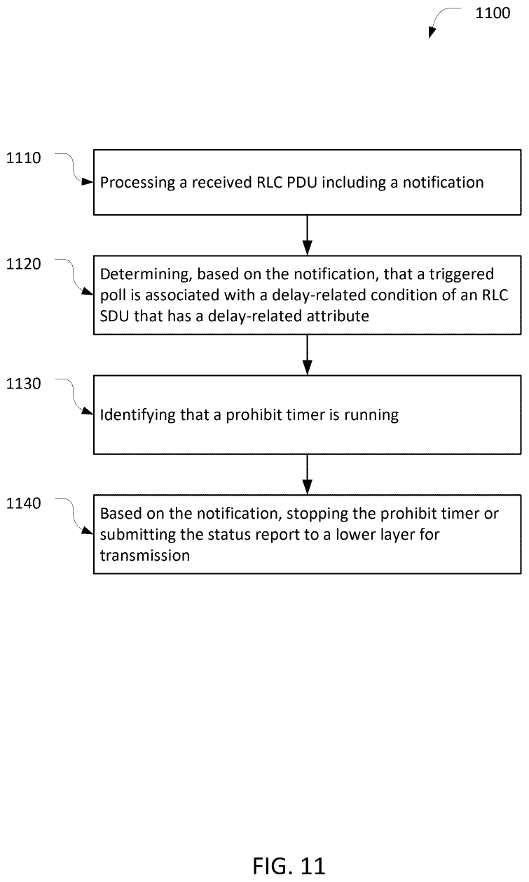

FIG. 11 illustrates another operation flow/algorithmic structure 1100 in accordance with some embodiments. The algorithmic structure 1100 may be implemented by an RLC transmitting entity such as, for example, the transmitting entity 150 of a UE, such as, for example, the UE 104 or UE 1400, or components thereof, for example, baseband processor circuitry 1404A; or the transmitting entity 150 of a base station, such as, for example, the base station 108 or base station 1500, or components thereof, for example, baseband processor circuitry 1504A.

The operation flow/algorithmic structure 1100 may include, at 1110, processing a received RLC PDU, including a notification. The notification may include information associated with the delay-related condition, PDU set-related condition, or the presence of delay-critical SDUs associated with a received poll requesting a status report.

The operation flow/algorithmic structure 1100 may include, at 1120, determining, based on the notification, that the triggered poll is associated with a delay-related, PDU set-related, or delay-critical SDUs.

The operation flow/algorithmic structure 1100 may include, at 1130, identifying that a prohibit timer is running. For example, the t-StatusProhibit timer is running, preventing the receiving entity 160 from immediately sending the status report.

The operation flow/algorithmic structure 1100 may include, at 1140, stopping the prohibit timer based on the notification or submitting the status report to a lower layer, ignoring the prohibit timer.

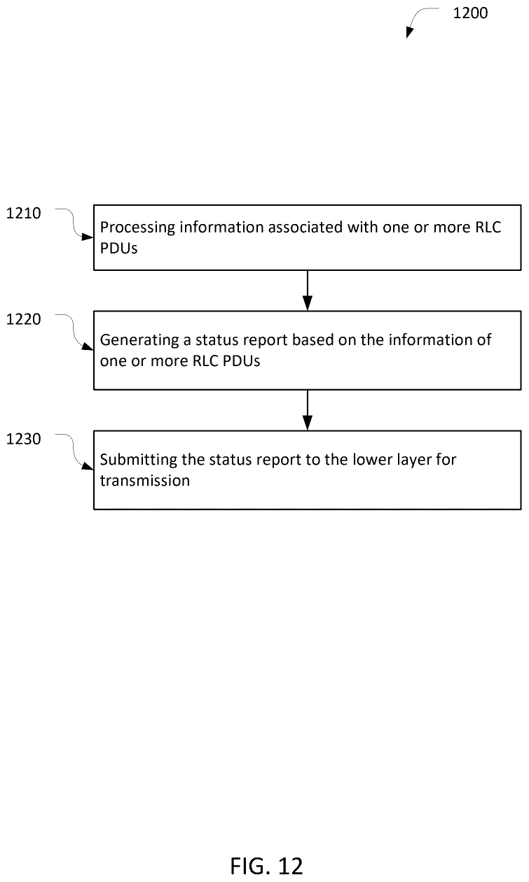

FIG. 12 illustrates another operation flow/algorithmic structure 1200 in accordance with some embodiments. The algorithmic structure 1200 may be implemented by an RLC transmitting entity such as, for example, the transmitting entity 150 of a UE, such as, for example, the UE 104 or UE 1400, or components thereof, for example, baseband processor circuitry 1404A; or the transmitting entity 150 of a base station, such as, for example, the base station 108 or base station 1500, or components thereof, for example, baseband processor circuitry 1504A.

The operation flow/algorithmic structure 1200 may include, at 1210, processing information associated with one or more RLC SDUs or PDUs. The transmitting entity 150 may regularly send information about delay-critical packets to the receiving entity 160.

The operation flow/algorithmic structure 1200 may include, at 1220, generating a status report based on the information. The receiving entity 160 may autonomously and, based on the information from the transmitting entity 150, generate and transmit a status report. In some instances, the receiving entity 160 may stop or ignore the operation of the prohibit timer.

In some embodiment, the receiving entity 160 may determine, based on the information of one or more RLC PDUs associated with the delay-related attribute, that the number of received RLC PDUs associated with the delay-related attribute is larger than a threshold.

In some embodiment, the receiving entity 160 may determine, based on the information of one or more RLC PDUs associated with the delay-related attribute, that a sequence number gap between a first received RLC PDU having the delay-related attribute and a second received RLC PDU having the delay-related attribute in a receiver buffer is larger than a threshold.

The operation flow/algorithmic structure 1200 may include, at 1230, submitting the status report to the lower layer for transmission. The receiving entity 160 may submit the status report for transmission at a valid and available transmission opportunity.

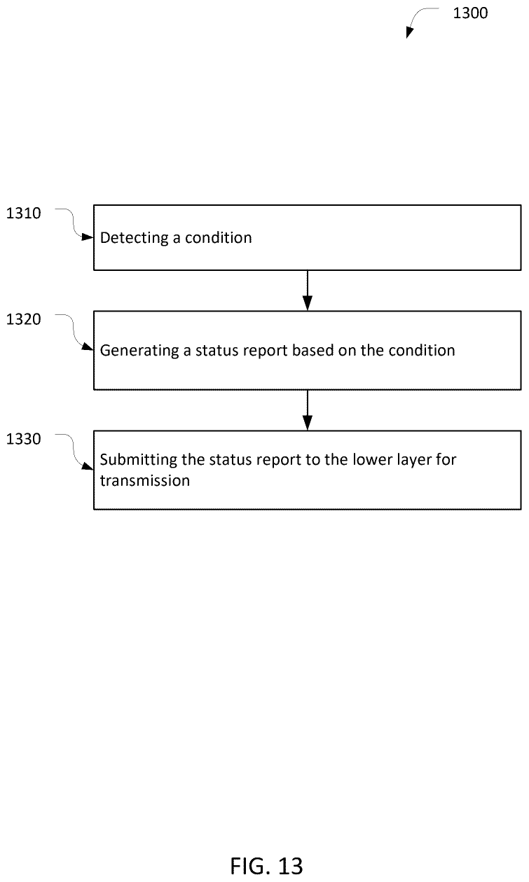

FIG. 13 illustrates another operation flow/algorithmic structure 1300 in accordance with some embodiments. The algorithmic structure 1300 may be implemented by an RLC transmitting entity such as, for example, the transmitting entity 150 of a UE, such as, for example, the UE 104 or UE 1400, or components thereof, for example, baseband processor circuitry 1404A; or the transmitting entity 150 of a base station, such as, for example, the base station 108 or base station 1500, or components thereof, for example, baseband processor circuitry 1504A.

The operation flow/algorithmic structure 1300 may include, at 1310, detecting a condition. The condition may include whether an RLC SDU is completely received; whether a state variable is updated, the state variable associated with a value of a sequence number following a last in-sequence completely received RLC SDU; whether a number of RLC SDUs that were previously unacknowledged in a last status report but are included in the status report exceeds a threshold; or whether a periodic transmission of the status report is configured.

The operation flow/algorithmic structure 1300 may include, at 1320, generating a status report based on the condition. The receiving entity 160 may autonomously or proactively generate a status report based on the detection of one or more of the conditions described above.

The operation flow/algorithmic structure 1300 may include, at 1330, submitting the status report to the lower layer for transmission.

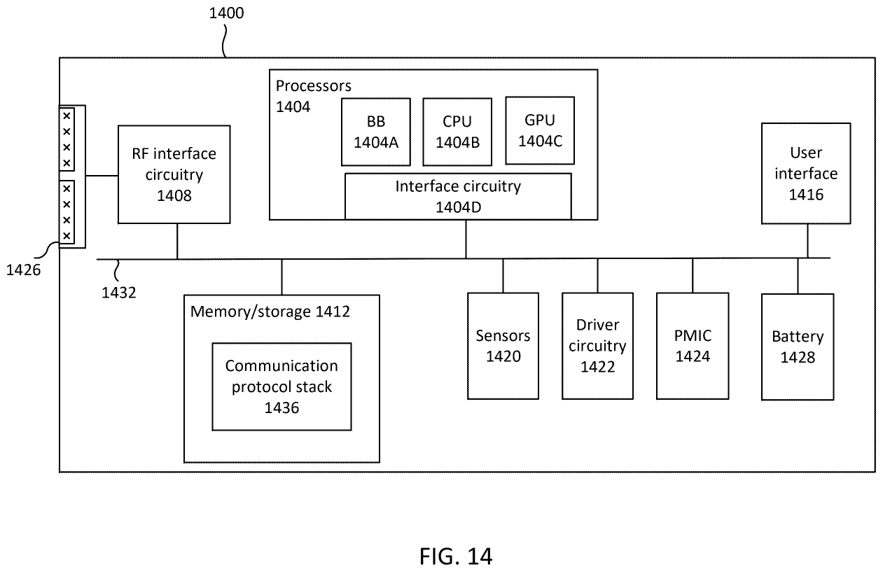

FIG. 14 illustrates a UE 1400 in accordance with some embodiments. The UE 1400 may be similar to and substantially interchangeable with the UE 104.

The UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1400 may include processors 1404, RF interface circuitry 1408, memory/storage 1412, user interface 1416, sensors 1420, driver circuitry 1422, power management integrated circuit (PMIC) 1424, antenna 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangements of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry, or processor circuitry that executes or otherwise operates computer-executable instructions, such as program code, software modules, or functional processes from memory/storage 1412 to cause the UE 1400 to perform operations as described herein. The processors 1404 may also include interface circuitry 1404D to communicatively couple the processor circuitry with one or more other components of the UE 1400.

In some embodiments, the baseband processor circuitry 1404A may access a communication protocol stack 1436 in the memory/storage 1412 to communicate over a 3GPP-compatible network. In general, the baseband processor circuitry 1404A may access the communication protocol stack 1436 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein.

The memory/storage 1412 includes any type of volatile or non-volatile memory that may be distributed throughout the UE 1400. In some embodiments, some of the memory/storage 1412 may be located on the processors 1404 themselves (for example, memory/storage 1412 may be part of a chipset that corresponds to the baseband processor circuitry 1404A), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, or phased array antennas. The antenna 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within or connected to the UE 1400. For example, driver circuitry 1422 may include a display driver to control and allow access to a display device, a touchscreen driver to control and allow access to a touchscreen interface, sensor drivers to obtain sensor readings of sensors 1420, and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

A battery 1428 may power the UE 1400, although in some examples, the UE 1400 may be mounted deployed in a fixed location and may have a power supply coupled to an electrical grid. The battery 1428 may be a lithium-ion battery, a metal-air battery, such as a zinc-air battery, an aluminum-air battery, a lithium-air battery, and the like. In some implementations, such as in vehicle-based applications, the battery 1428 may be a typical lead-acid automotive battery.

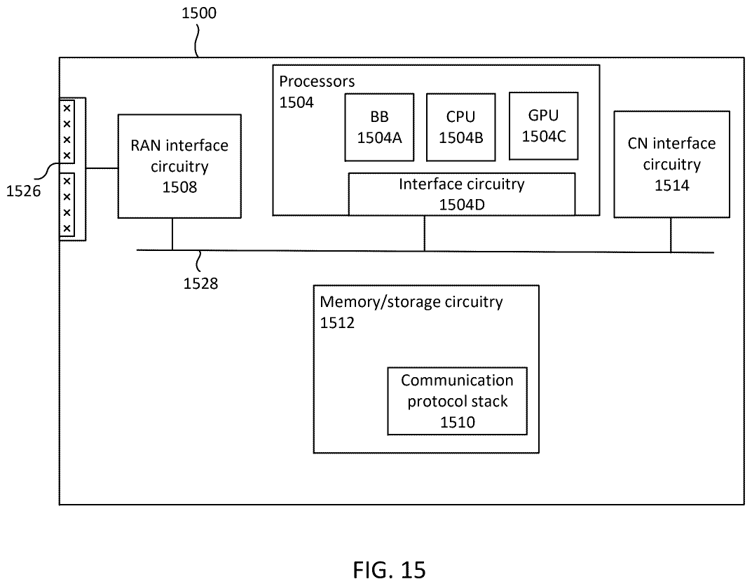

FIG. 15 illustrates a network device 1500 in accordance with some embodiments. The network device 1500 may be similar to and substantially interchangeable with base station 108.

The network device 1500 may include processors 1504, RF interface circuitry 1508 (if implemented as a base station), core network (CN) interface circuitry 1514, memory/storage circuitry 1512, and antenna structure 1526.

The components of the network device 1500 may be coupled with various other components over one or more interconnects 1528.

The processors 1504, RF interface circuitry 1508, memory/storage circuitry 1512 (including communication protocol stack 1510), antenna structure 1526, and interconnects 1528 may be similar to like-named elements shown and described with respect to FIG. 14.

The processors 1504 may include processor circuitry such as, for example, baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage circuitry 1512 to cause the UE 1400 to perform operations as described herein. The processors 1504 may also include interface circuitry 1504D to communicatively couple the processor circuitry with one or more other components of the network device 1500.

The CN interface circuitry 1514 may provide connectivity to a core network, for example, a 5^{th} Generation Core network (5GC) using a 5GC-compatible network interface protocol such as carrier Ethernet protocols or some other suitable protocol. Network connectivity may be provided to/from the network device 1500 via a fiber optic or wireless backhaul. The CN interface circuitry 1514 may include one or more dedicated processors or FPGAs to communicate using one or more of the aforementioned protocols. In some implementations, the CN interface circuitry 1514 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### Examples

In the following sections, further exemplary embodiments are provided.

Example 1 includes a method including: identifying a radio link control (RLC) service data unit (SDU), wherein the RLC SDU is associated with a delay-related attribute; detecting a delay-related condition of poll triggering based on said identifying the RLC SDU; setting a polling flag in an RLC protocol data unit (PDU) based on the detection of the delay-related condition of poll triggering; and submitting the RLC PDU to a lower layer for transmission.

Example 2 includes the method of example 1 or some other examples herein, wherein the delay-related attribute is being delay-critical.

Example 3 includes the method of examples 1 or 2 or some other example herein, wherein said detecting the delay-related condition of poll triggering includes: determining that at least one RLC SDU in a transmitter buffer is a delay-critical RLC SDU; determining that a number of RLC PDUs corresponding to delay-critical RLC SDUs sent after a last status report is received is greater than or equal to a first threshold; determining that a number of bytes of RLC PDUs corresponding to delay-critical RLC PDUs sent after a last status report is received is greater than or equal to a second threshold; determining that a number of RLC PDUs sent since a last transmission of an RLC PDU corresponding to delay-critical RLC SDUs is greater than or equal to a third threshold; or determining that a number of bytes of RLC PDUs sent after a last transmission of an RLC PDU corresponding to delay-critical RLC SDUs is greater than or equal to a fourth threshold.

Example 4 includes the method of any of examples 1-3 or some other example herein, wherein said detecting the delay-related condition of poll triggering includes: determining that a number of RLC PDUs corresponding to delay-critical RLC SDUs sent after a last status report is received is less than a first threshold configured by radio resource control (RRC); determining that a number of bytes of RLC PDUs corresponding to delay-critical RLC PDUs sent after a last status report is received is less than a second threshold configured by RRC; determining that a number of RLC PDUs sent since a last transmission of an RLC PDU corresponding to delay-critical RLC SDUs is less than a third threshold configured by RRC; or determining that a number of bytes of RLC PDUs sent after a last transmission of an RLC PDU corresponding to delay-critical RLC SDUs is less than a fourth threshold configured by RRC.

Example 5 includes the method of any of examples 1-4 or some other example herein, wherein said detecting the delay-related condition of poll triggering includes: determining that a number of RLC PDUs corresponding to delay-critical RLC SDUs sent after a last status report is received is greater than or equal to a first threshold based on a radio resource control (RRC) poll PDU (pollPDU) parameter; determining that a number of bytes of RLC PDUs corresponding to delay-critical RLC PDUs sent after a last status report is received is greater than or equal to a second threshold is based on an RRC poll byte (pollByte) parameter; determining that a number of RLC PDUs sent since a last transmission of an RLC PDU corresponding to delay-critical RLC SDUs is greater than or equal to a third threshold based on an RRC pollPDU parameter; or determining that a number of bytes of RLC PDUs sent after a last transmission of an RLC PDU corresponding to delay-critical RLC SDUs is greater than or equal to a fourth threshold based on an RRC pollByte parameter.

Example 6 includes the method of any of examples 1-5 or some other example herein, further including: detecting, by a transmitting side of the RLC, a PDU set-related condition associated with a PDU set corresponding to the PDUs or SDUs of the RLC, wherein said setting the polling flag in the RLC PDU is based further on said detecting the PDU set-related condition.

Example 7 includes the method of any of examples 1-6 or some other example herein, wherein the PDU set-related condition is associated with: importance information of the PDU set; a size of the PDU set; a number of PDUs in the PDU set; or a determination of whether a last PDU of the PDU set is received by the transmitting side of the RLC.

Example 8 includes the method of any of examples 1-7 or some other example herein, wherein the PDU set-related condition is associated with the importance information of the PDU set, and the method further includes: processing a message including an activation indication or a deactivation indication associated with an importance information-based discarding; and setting a polling flag in the RLC PDU further based on the message.

Example 9 includes the method of any of examples 1-8 or some other examples herein, further including: generating a notification including a field that indicates a poll is triggered based on said detecting the delay-related condition of poll triggering.

Example 10 includes the method of any of examples 1-9 or some other examples herein, wherein the notification is included in the RLC PDU.

Example 11 includes the method of an of examples 1-10 or some other examples herein, further including: generating a notification including a field that indicates one or more sequence numbers respective to the SDU associated with the delay-related attribute.

Example 12 includes a method including: processing a received radio link control (RLC) protocol data unit (PDU) that includes a notification; determining, based on the notification, that a triggered poll is associated with a delay-related condition of an RLC service data unit (SDU) that has a delay-related attribute; identifying that a prohibit timer associated with a status report is running; and based on said determining that the triggered poll is associated with the delay-related condition of the RLC SDU, stopping the prohibit timer or submitting the status report to a lower layer for transmission.

Example 13 includes the method of example 12 or some other examples herein, wherein the delay-related attribute is being delay-critical.

Example 14 includes the method of examples 12 or 13 or some other example herein, wherein the delay-related condition associated with the RLC SDU includes: whether at least one RLC SDU arrived in a transmitter buffer is a delay-critical RLC SDU; whether a number of RLC PDUs corresponding to delay-critical RLC SDUs sent after a last status report is received is less than a first threshold; whether a number of bytes of RLC PDUs corresponding to delay-critical RLC PDUs sent after a last status report is received is less than a second threshold; whether a number of RLC PDUs sent since a last transmission of an RLC PDU corresponding to delay-critical RLC SDUs is less than a third threshold; and whether a number of bytes of RLC PDUs sent after a last transmission of an RLC PDU corresponding to delay-critical RLC SDUs is less than a fourth threshold.

Example 15 includes a method including: processing information associated with a delay-related attribute of a received radio link control (RLC) protocol data unit (PDU); generating a status report associated with successful receptions of one or more RLC PDUs; and submitting the status report to a lower layer for transmission.

Example 16 includes the method of example 15 or some other examples herein, further including: identifying that a prohibit timer associated with the status report is running.

Example 17 includes the method of examples 15 or 16 or some other example herein, further including: determining, based on the information of one or more RLC PDUs associated with the delay-related attribute, that a number of received RLC PDUs associated with the delay-related attribute is larger than a threshold; and submitting the status report to the lower layer for transmission based on said determining that the number of received RLC PDUs associated with the delay-related attribute is larger than the threshold.

Example 18 includes the method of any of examples 15-17 or some other example herein, further including: determining, based on the information of one or more RLC PDUs associated with the delay-related attribute, that a sequence number gap between a first received RLC PDU having the delay-related attribute and a second received RLC PDU having the delay-related attribute in a receiver buffer is larger than a threshold; and submitting the status report to the lower layer for transmission based on said determining that the sequence number gap between the first received RLC PDU and the second received RLC PDU is larger than the threshold.

Example 19 includes the method of any of examples 15-18 or some other examples herein, wherein the delay-related attribute is being delay-critical.

Example 20 includes a method including: detecting a condition; generating a status report associated with successful receptions of a radio link control (RLC) protocol data unit (PDU) based on said detecting the condition; and submitting the status report to a lower layer for transmission.

Example 21 includes the method of example 20 or some other example herein, wherein the condition includes: whether an RLC service data unit (SDU) is completely received; whether a state variable is updated, the state variable associated with a value of a sequence number following a last in-sequence completely received RLC SDU; whether a number of RLC SDUs that were previously unacknowledged in a last status report but are included in the status report exceeds a threshold; or whether a periodic transmission of the status report is configured.

Example 22 includes the method of examples 20 or 21 or some other examples herein, wherein the status report includes a notification that a receiving window associated with a transmission window has moved forward.

Example 23 includes the method of any of examples 20-22 or some other examples herein, wherein the status report is an RLC control PDU, a medium access control (MAC) control element (CE), an uplink control information (UCI), or a downlink control information (DCI).

Another example may include an apparatus comprising means to perform one or more elements of a method described in or related to any of examples 1-23, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-23, or any other method or process described herein.

Another example may include an apparatus comprising logic, modules, or circuitry to perform one or more elements of a method described in or related to any of examples 1-23, or any other method or process described herein.

Another example may include a method, technique, or process as described in or related to any of examples 1-23, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-23, or portions thereof.

Another example may include a signal as described in or related to any of examples 1-23, or portions or parts thereof.

Another example may include a datagram, information element, packet, frame, segment, PDU, or message as described in or related to any of examples 1-23, or portions or parts thereof, or otherwise described in the present disclosure.

Another example may include a signal encoded with data as described in or related to any of examples 1-23, or portions or parts thereof, or otherwise described in the present disclosure.

Another example may include a signal encoded with a datagram, IE, packet, frame, segment, PDU, or message as described in or related to any of examples 1-23, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Another example may include a computer program comprising instructions, wherein execution of the program by a processing element is to cause the processing element to carry out the method, techniques, or process as described in or related to any of examples 1-23, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying a radio link control (RLC) service data unit (SDU), wherein the RLC SDU is associated with a delay-related attribute;
detecting a delay-related condition of poll triggering based on said identifying the RLC SDU;
setting a polling flag in an RLC protocol data unit (PDU) based on the detection of the delay-related condition of poll triggering; and
submitting the RLC PDU to a lower layer for transmission.

2. The method of claim 1, wherein the delay-related attribute is being delay-critical.

3. The method of claim 1, wherein said detecting the delay-related condition of poll triggering comprises:
determining that at least one RLC SDU in a transmitter buffer is a delay-critical RLC SDU;
determining that a number of RLC PDUs corresponding to delay-critical RLC SDUs sent after a last status report is received is greater than or equal to a first threshold;
determining that a number of bytes of RLC PDUs corresponding to delay-critical RLC PDUs sent after a last status report is received is greater than or equal to a second threshold;
determining that a number of RLC PDUs sent since a last transmission of an RLC PDU corresponding to delay-critical RLC SDUs is greater than or equal to a third threshold; or
determining that a number of bytes of RLC PDUs sent after a last transmission of an RLC PDU corresponding to delay-critical RLC SDUs is greater than or equal to a fourth threshold.

4. The method of claim 1, wherein said detecting the delay-related condition of poll triggering comprises:
determining that a number of RLC PDUs corresponding to delay-critical RLC SDUs sent after a last status report is received is greater than or equal to a first threshold configured by radio resource control (RRC);
determining that a number of bytes of RLC PDUs corresponding to delay-critical RLC PDUs sent after a last status report is received is greater than or equal to a second threshold configured by RRC;
determining that a number of RLC PDUs sent since a last transmission of an RLC PDU corresponding to delay-critical RLC SDUs is greater than or equal to a third threshold configured by RRC; or
determining that a number of bytes of RLC PDUs sent after a last transmission of an RLC PDU corresponding to delay-critical RLC SDUs is greater than or equal to a fourth threshold configured by RRC.

5. The method of claim 1, wherein said detecting the delay-related condition of poll triggering comprises:
determining that a number of RLC PDUs corresponding to delay-critical RLC SDUs sent after a last status report is received is greater than or equal to a first threshold based on a radio resource control (RRC) poll PDU (pollPDU) parameter;
determining that a number of bytes of RLC PDUs corresponding to delay-critical RLC PDUs sent after a last status report is received is greater than or equal to a second threshold is based on an RRC poll byte (pollByte) parameter;
determining that a number of RLC PDUs sent since a last transmission of an RLC PDU corresponding to delay-critical RLC SDUs is greater than or equal to a third threshold based on an RRC pollPDU parameter; or
determining that a number of bytes of RLC PDUs sent after a last transmission of an RLC PDU corresponding to delay-critical RLC SDUs is greater than or equal to a fourth threshold based on an RRC pollByte parameter.

6. The method of claim 1, further comprising:
detecting, by a transmitting side of the RLC, a PDU set-related condition associated with a PDU set corresponding to the PDUs or SDUs of the RLC,
wherein said setting the polling flag in the RLC PDU is based further on said detecting the PDU set-related condition.

7. The method of claim 6, wherein the PDU set-related condition is associated with:
importance information of the PDU set;
a size of the PDU set;
a number of PDUs in the PDU set; or
a determination of whether a last PDU of the PDU set is received by the transmitting side of the RLC.

8. The method of claim 7, wherein the PDU set-related condition is associated with the importance information of the PDU set, and the method further comprises:
processing a message including an activation indication or a deactivation indication associated with an importance information-based discarding; and
setting a polling flag in the RLC PDU further based on the message.

9. The method of claim 1, further comprising:
generating a notification including a field that indicates a poll is triggered based on said detecting the delay-related condition of poll triggering.

10. The method of claim 9, wherein the notification is included in the RLC PDU.

11. The method of claim 1, further comprising:
generating a notification including a field that indicates one or more sequence numbers respective to the SDU associated with the delay-related attribute.

12. A method comprising:
processing a received radio link control (RLC) protocol data unit (PDU) that includes a notification;
determining, based on the notification, whether a triggered poll is associated with a delay-related condition of an RLC service data unit (SDU), wherein the RLC SDU has a delay-related attribute;
determining that a prohibit timer associated with a status report is running; and
based on said determining that the triggered poll is associated with the delay-related condition of the RLC SDU, stopping the prohibit timer or submitting the status report to a lower layer for transmission after expiration of the prohibit timer.

13. The method of claim 12, wherein said determining, based on the notification, whether a triggered poll is associated with a delay-related condition of an RLC service data unit (SDU) includes determining, based on the notification, that a triggered poll is associated with a delay-related condition of an RLC service data unit (SDU), and the method further comprises:
stopping the prohibit timer; and
submitting the status report to a lower layer for transmission.

14. The method of claim 12, wherein said determining, based on the notification, whether a triggered poll is associated with a delay-related condition of an RLC service data unit (SDU) includes determining, based on the notification, that a triggered poll is not associated with a delay-related condition of an RLC service data unit (SDU), and the method further comprises:
waiting for expiration of the prohibit timer; and
submitting the status report to a lower layer for transmission.

15. The method of claim 12, wherein the delay-related attribute is being delay-critical, and the delay-related condition associated with the RLC SDU comprises:
whether at least one RLC SDU arrived in a transmitter buffer is a delay-critical RLC SDU;
whether a number of RLC PDUs corresponding to delay-critical RLC SDUs sent after a last status report is received is greater than or equal to a first threshold;
whether a number of bytes of RLC PDUs corresponding to delay-critical RLC PDUs sent after a last status report is received is greater than or equal to a second threshold;
whether a number of RLC PDUs sent since a last transmission of an RLC PDU corresponding to delay-critical RLC SDUs is greater than or equal to a third threshold; and
whether a number of bytes of RLC PDUs sent after a last transmission of an RLC PDU corresponding to delay-critical RLC SDUs is greater than or equal to a fourth threshold.

16. One or more non-transitory computer-readable media having instructions that, when executed, cause processing circuitry to:
process information of one or more radio link control (RLC) protocol data units (PDUs) associated with a delay-related attribute, the information received from an RLC transmitting entity;
trigger generating a status report based on the information of one or more RLC PDUs; and
submit the status report to a lower layer for transmission.

17. The one or more non-transitory computer-readable media of claim 16, wherein the instructions, when executed, further cause the processing circuitry to:
identify that a prohibit timer associated with the status report is running.

18. The one or more non-transitory computer-readable media of claim 16, wherein the delay-related attribute is being delay-critical.

19. The one or more non-transitory computer-readable media of claim 16, wherein the instructions, when executed, further cause the processing circuitry to:
determine, based on the information of one or more RLC PDUs associated with the delay-related attribute, that a number of received RLC PDUs associated with the delay-related attribute is larger than a threshold; and
submit the status report to the lower layer for transmission based on said determining that the number of received RLC PDUs associated with the delay-related attribute is larger than the threshold.

20. The one or more non-transitory computer-readable media of claim 16, wherein the instructions, when executed, further cause the processing circuitry to:
determine, based on the information of one or more RLC PDUs associated with the delay-related attribute, that a sequence number gap between a first received RLC PDU having the delay-related attribute and a second received RLC PDU having the delay-related attribute in a receiver buffer is larger than a threshold; and
submitting the status report to the lower layer for transmission based on said determining that the sequence number gap between the first received RLC PDU and the second received RLC PDU is larger than the threshold.
